(19) United States
(12) Patent Application Publication
(10) Pub. No.: US 2006/0052079 A1
(43) Pub. Date: Mar. 9, 2006

(54) Method for controlling the power consumption in an electronic appliance

(76) Inventors: Karsten Elsholz, BERLIN (DE); Burkhard Meischke, Berlin (DE); Hartmut Schroter, Brieselang (DE); Andrzej Trebisz, Berlin (DE)

Correspondence Address: BELL, BOYD & LLOYD, LLC, P. O. BOX 1135, CHICAGO, IL, 60690-1135, US

(21) Appl. No.: 10/527,015

(22) PCT Filed: Sep. 3, 2003
(86) PCT No.: PCT/DE03/02976

§ 371 Date: Apr. 13, 2005

(30) Foreign Application Priority Data
Sep. 6, 2002 (DE) 102 44 065.4

(51) Int. Cl. H04B 1/16

(52) U.S. Cl. 455/343.4; 455/343.1

(57) ABSTRACT

A method is provided for controlling the power consumption in an electronic appliance which has a data interface suitable for data transmissions, the method involving data transmissions which arise being monitored and registered and the power consumption in the electronic appliance being controlled on the basis of the registered data transmissions which arise. The present invention also provides an electronic appliance which has at least the following elements: a data interface for performing data transmissions, a monitoring unit for monitoring and registering data transmissions which arise, and a control unit, coupled to the monitoring unit, for controlling and setting a power consumption on the basis of the registered data transmissions which arise.

### BACKGROUND OF THE INVENTION

The present invention relates to a method for controlling the power consumption in an electronic appliance and to a corresponding electronic appliance. In general, it is necessary to minimize the power consumption by battery-operated or storage-battery-operated electronic appliances. Many electronic appliances, such as computers or PCs (Personal Computers), laptops, PDAs (Personal Digital Assistants) or mobile telephones (mobile phones), have an interface for interchanging or transmitting data; i.e., a data interface. At the same time, the addressability, or the ability to use such a data interface for transmission, must not be impaired, remembering that the power consumption has been minimized. In addition, applications which control the electronic appliance, such as terminal programs or fax programs in the case of PC-based applications, need to operate without being matched to standardized interfaces and protocols.

The present invention thus seeks to provide a method and a corresponding electronic appliance which can be used to achieve a minimum power consumption without impairing the operation of the electronic appliance in doing so.

### SUMMARY OF THE INVENTION

Accordingly, a method is provided for controlling the power consumption in an electronic appliance which has a data interface which is suitable for data transmissions, the method involving data transmissions which arise being monitored and registered and a power consumption in the electronic appliance being controlled on the basis of the registered data transmissions which arise.

As such, in accordance with the present invention, the power consumption within the electronic appliance is controlled using the volume of data in the electronic appliance.

It is known that a data interface provided in electronic appliances, such as in mobile radios, is not active when the electronic appliance is in a provided power-saving mode. [Conversely, this results in the power-saving mode in the electronic appliance is permanently exited when the data interface has contact made with it or is activated.] Thus, once the data interface has been activated, the electronic appliance being no longer automatically reset to the power-saving mode even after the termination of a data transmission, but rather remains in the state or mode which it adopted when the data interface was active. In the case of mobile telephones, for example, this results in up to six times the power consumption without data transmission. To date, the power-saving mode can be controlled only using special commands. According to GSM specification 3GPP TS 07.07 V7.7.0 (2001-12), a command called “AT+CFUN” disables the data interface in the electronic appliance and switches to the power-saving mode. Another change is that the presence of a cable connection is detected by the appliance using control lines. While the cable connection exists, the power-saving mode is exited and is resumed only when the data cable is removed; that is, when the cable connection is interrupted.

There is also a known method for controlling the power consumption in a computer, where the computer includes a data interface (a keyboard), a monitoring unit for monitoring and registering data (input controller) and a control unit, coupled to the monitoring unit, for controlling the power consumption. If the data interface is not transmitting any data (the user does not register any text), the control unit automatically (after a period of time) puts the computer into a power-saving mode. The power-saving mode is exited when the user presses a button.

U.S. Pat. No. 6,018,232 discloses a computer having a receiver for receiving paging messages. The computer is, first of all, in a sleep mode. When the paging message has been received, the computer is switched to a standby state. Depending on the content of the paging message, certain programs automatically can be started in the computer's main processor.

US 2002/0035702 A1 discloses a method for automatically waking up a computer which includes a modem, the computer initially being in a power-saving mode (suspend mode). When the modem receives a first signal, it sends a wake-up signal to the computer. The computer is now in a standby state. The modem now sends a second signal (e.g. an incoming fax) to the computer.

In line with the present invention, mechanisms which are now introduced for data flow control within an electronic appliance are used to control a power consumption within the electronic appliance.

In one preferred embodiment of the inventive method, the data transmissions which arise are monitored and registered using control lines. Control lines are signal lines which indicate to a remote station involved in the data transmission that the appliance can receive further data. If the electronic appliance is a GSM module, the data interface provided therein is in the form of a serial interface with control lines and is called an RS232 interface. For the RS232 interface, a control line of this type is known, by way of example, by the name “Clear to Send” (CTS), and for a printer interface it is known by the name “Acknowledge” (ACK).

In another preferred embodiment of the inventive method, data flow control is brought into action by commands, such as by control characters Xon/Xoff, which are contained in the datastream. This is also called software flow control.

Also in accordance with the present invention, data flow control or monitoring and registering of the data transmissions which arise within the electronic appliance allows an application to use the data interface, or to transmit data via this data interface, cyclically. As such, the data interface is activated or can be addressed cyclically and is deactivated or can no longer be addressed only at the time at which the end of the data transmissions is registered.

Preferably, there is a power-saving mode into which the electronic appliance is put when no data transmissions are registered as arising and which the electronic appliance exits when data transmissions are registered as arising.

With particular preference, the electronic appliance is put into and/or taken out of the power-saving mode automatically. While the data interface is being used, the power-saving mode is exited. As soon as a volume of data is no longer detected or registered, the electronic appliance automatically reverts to the power-saving mode.

One advantage of the present invention is that two independent methods which were originally introduced separately to an electronic appliance, namely a power-saving technology and data flow control, are effectively coupled to one another, within an electronic appliance such that a power-saving method which is controlled by the volume of data within the electronic appliance has been developed.

In addition, the present invention provides an electronic appliance which has at least the following elements:

a data interface for performing data transmissions;

monitoring unit for monitoring and registering data transmissions which arise; and

a control unit, coupled to the monitoring unit, for controlling and setting a power consumption on the basis of the registered data transmissions which arise.

Preferably, the data interface is in the form of an interface with control lines.

In another preferred embodiment of the inventive electronic appliance, the electronic appliance is a GSM module.

In addition, a power-saving mode is preferably provided in the inventive electronic appliance. If the electronic appliance is in this power-saving mode, then the power consumption is at a minimum.

In a GSM module, the data interface provided therein is in the form of a serial interface with control lines. This interface is known by the name RS232 interface.

In the case of a GSM module, the data interface is provided cyclically on the basis of a “GSM paging cycle.” The term “paging” involves an item of information for transmission from a base station in a mobile radio network, which information needs to be communicated to the individual mobile stations as an item of system-specific information. In this case, the mobile radio network prescribes a period duration in which the GSM module can fetch information from the mobile radio network. The GSM module therefore exits in the state with the lowest power consumption for a short time. In addition, a control line, a “Clear to Send” (CTS) control line, is used to signal to an application that the data interface is ready to transmit data. If events with a mobile termination are involved, for example, such as SMS or call setup, the GSM module automatically exits the state with the lowest power consumption (the power-saving mode), signals this using the control line “Clear to Send” (CTS) and, after the event, reverts to the old state (i.e., to the power-saving mode), unless the application sends data to the GSM module while the control line CTS is set. If this is the case, the GSM module does not adopt the state with the lowest power consumption until no more data are being received and a settable time, such as 2 seconds, has elapsed. In this case, the application requires no activities or adjustments; that is, the GSM module's power-saving mode need neither be restarted nor exited using commands or control lines.

Additional features and advantages of the present invention are described in, and will be apparent from, the following Detailed Description of the Invention and the Figures.

### BRIEF DESCRIPTION OF THE FIGURES

FIG. 1 shows a schematic illustration of the flow of one embodiment of the inventive method.

### DETAILED DESCRIPTION OF THE INVENTION

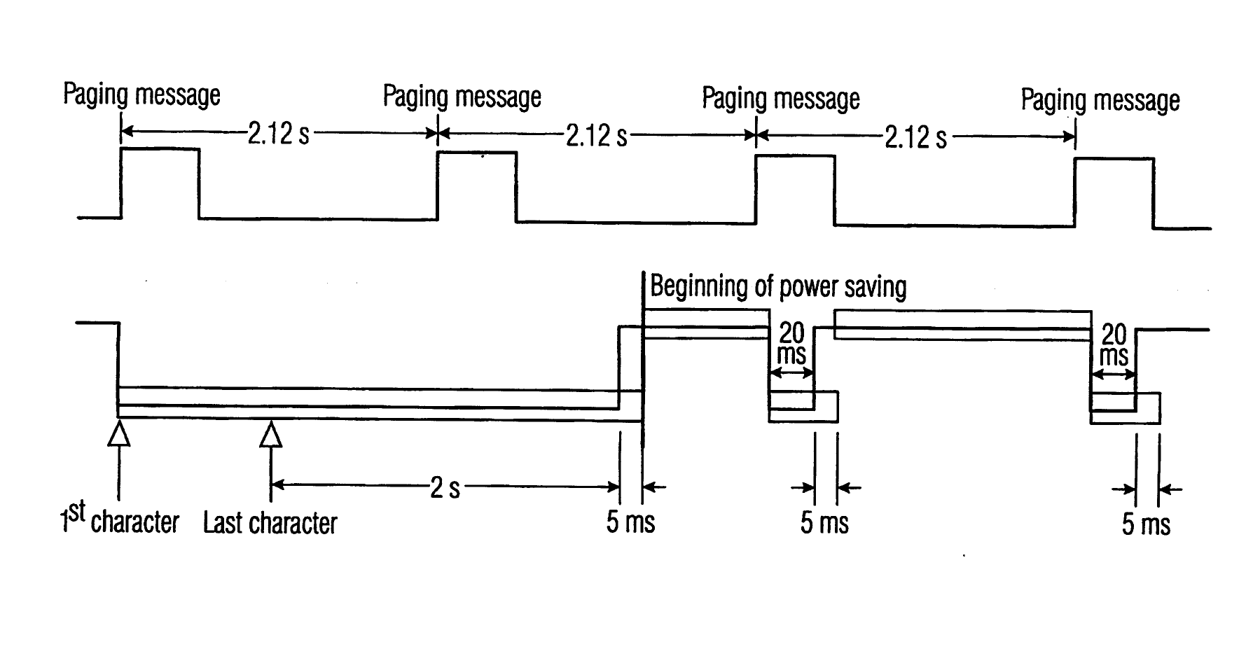

FIG. 1 shows the flow of an embodiment of the inventive method for a GSM module. It shows the timing of a GSM paging cycle. As already described, the term “Paging” involves an item of information for transmission from a base station in a mobile radio network which information is communicated to the GSM module as system-specific information in the form of a “Paging Message” using a period duration of 2.12 seconds which is prescribed by the mobile radio network. The top portion of FIG. 1 shows the periodic transmission of the “Paging Message” in the form of a periodic square-wave signal. The bottom region shows a corresponding time profile for the enabling or addressability of a data interface in the GSM module, linked to a corresponding power consumption state. Looking at the timing in FIG. 1 from left to right, information is thus communicated to the GSM module using a first “Paging Message.” In this case, the data interface in the GSM module is enabled and the GSM module exits in the state with the lowest power consumption (i.e., the power-saving mode) and changes to a type of standby state with a higher power consumption, which in this case is shown in light grey shading. At the same time, a control line, namely a “Clear to Send” (CTS) control line, is used to signal to an application that the data interface in the GSM module is ready to transmit data. In the present example, an application (not shown here) then sends data to the data interface. The start of the transmitted data is called the “1^{st} character” in this case, and the end is called the “Last character.” On account of this, the data interface will remain in the standby state for a longer time. Only when no more data are being received and a settable time, in this case 2 seconds, has elapsed does the GSM module readopt the state with the lowest power consumption (i.e., the power-saving mode) which is shown in dark shading in this case. When another “Paging Message” is sent by the base station, the GSM module exits the power-saving mode for a short time, in this case 20 ms, and will revert to the power-saving mode again when no further data are being sent by an application. In this case, a short relaxation time of approximately 5 ms elapses again. An application requires no adjustments.

Although the present invention has been described with reference to specific embodiments, those of skill in the art will recognize that changes may be made thereto without departing from the spirit and scope of the present invention as set forth in the hereafter appended claims.

1-5. (canceled)

6. A method for controlling power consumption in an electronic appliance which has a data interface suitable for data transmission, the method comprising:
providing that the electronic appliance automatically turn itself on cyclically to a standby state;
signaling to an application, in connection with the turning-on of the standby state in the electronic appliance, that the data interface has been enabled for data transmission;
registering data transmissions, via the electronic appliance, from the application via the data interface; and
automatically turning on a power-saving mode in the electronic appliance when no data transmissions from the application via the data interface are registered.

7. A method for controlling power consumption in an electronic appliance as claimed in claim 6, wherein the power-saving mode is not turned on after the electronic appliance has not registered any data transmissions via the data interface until after a time which can be predetermined in the electronic appliance has elapsed.

8. An electronic appliance, comprising:
a data interface for performing data transmissions;
parts for automatically turning on a standby state in the electronic appliance cyclically;
parts for connecting the turning-on of the standby state in the electronic appliance to the signaling to an application that the data interface has been enabled for data transmission;
parts for registering data transmissions by the application via the data interface; and
parts for automatically turning on a power-saving mode in the electronic appliance when no data transmissions from the application via the data interface are registered.

9. An electronic appliance as claimed in claim 8, wherein the electronic appliance is a GSM module.

10. An electronic appliance as claimed in claim 8, wherein the power-saving mode is provided as a state with a lowest power consumption.
